(19) United States
(12) Patent Application Publication
(10) Pub. No.: US 2003/0225596 A1
(43) Pub. Date: Dec. 4, 2003

(54) Biometric security for access to a storage device for a healthcare facility

(76) Inventors: Bill R. Richardson, Etobicoke (CA); Alex Dolgovykh, Richmond Hill (CA); Stan I. Schwartz, Toronto (CA)

Correspondence Address: FRANCIS C. KOWALIK, ESQ., CORPORATE COUNSEL, BAXTER INTERNATIONAL INC., LAW DEPARTMENT, ONE BAXTER PARKWAY, DF2-2E, DEERFIELD, IL, 60015, US

(21) Appl. No.: 10/159,802

(22) Filed: May 31, 2002

(51) Int. Cl. G06F 17/60

(52) U.S. Cl. 705/2

(57) ABSTRACT

An identity verification device for use with a computer-based system with an encrypted electronic key (128), a memory containing a first electronic biometric identification associated with the key, a biometric scanner (122) that generates a second electronic biometric identification and a processor (118) that generates an identity verification signal based at least in part by comparing the first and second electronic biometric identification, which can occur while the system is on or off line. The device can terminate access to a cabinet upon the proximate removal of the encrypted electronic key (128).

### RELATED APPLICATIONS

The present application claims priority from U.S. patent application Ser. No. 60/377,027 filed Apr. 30, 2002; U.S. patent application Ser. No. 60/376,625, filed Apr. 30, 2002; U.S. patent application Ser. No. 60/376,655, filed Apr. 30, 2002; and U.S. patent application Ser. No. 10/135,180 filed Apr. 30, 2002, which is a continuation-in-part of copending U.S. patent applcation Ser. No. 10/059,929 filed Jan. 29, 2002, and incorporates such applications herein by reference.

Additionally, the present application is being filed concurrently with and incorporates by reference the following applications: “Automated Messaging Center System and Method For Use With A Healthcare System” (Attorney Docket No. EIS-5849 (1417G P 749)), Ser. No. ______; “System And Method For Obtaining Information From A Bar Code For Use With A Healthcare System” (Attorney Docket No. EIS-5897 (1417G P 754)), Ser. No. ______; “Infusion Therapy Bar Coding System and Method” (Attorney Docket No. EIS-5850 (01417GP0750)), Ser. No. ______; “System and Method for Providing Multiple Units of Measurement” (Attorney Docket No. EIS-5851(1417GP0751)), Ser. No. ______; “Nursing Order Workflow System and Method” (Attorney Docket No. EIS-5899(1417GP0756)), Ser. No. ______; “Healthcare Database Management Offline Backup and Synchronization System and Method” (Attorney Docket No. EIS-5895(1417G-P752)), Ser. No. ______; “Storage Device For Health Care Facility” (Attorney Docket No. EIS-5848(1417G P 747)), Ser. No. ______; “System And Method For Supporting Clinical Decisions During Patient Care And Treatment” (Attorney Docket No. EIS-5896(1417G-P753)), Ser. No. ______; “System And Method For Facilitating Patient Care And Treatment” (Attorney Docket No. EIS-5898(1417G-P755)), Ser. No. ______; “System And Method For Facilitating Orders During Patient Care And Treatment” (Attorney Docket No. EIS-5900(1417G-P757)), Ser. No. ______; and, “Pharmacy System And Method” (Attorney Docket No. EIS-5901(1417G-P758)), Ser. No. ______.

### TECHNICAL FIELD

The present invention relates generally to controlling access to medication locked in a depot, and more specifically to using biometric matching in combination with an electronic key for controlling access to the medical storage depot.

### BACKGROUND OF THE INVENTION

In order to control inventory properly and improve security with regard to medication, typically, a pharmacy manually logs the identity of a nurse receiving the medication, the type of medication dispensed, the amount of medication dispensed, the time of release of the medication, and other information necessary for proper inventory control. The nurse also manually records the medication received, the amount of medication delivered, the patient to whom the medication was delivered, and the time the patient received the medication. Furthermore, if the controlled substance was subsequently delivered to the patient after the original nurse's shift was over, the additional nurse would be required to manually record the same type of information regarding her handling of the medication. Thus, administration of a controlled substance to a patient is both labor and time intensive, as it requires a commitment of a number of individuals and substantial time is involved in manually recording the information regarding the distribution.

More recently, containers of medical supplies have been remotely located within the medical care facility at stations closer to the patients receiving the medication. In this system, while the pharmacy releases the containers of medicine to the various nurse substations, the inventory information is still required to be recorded. The containers of medicine are then stored within locked cabinets at each nurse substation with the nurses retrieving the medicine from the locked cabinets and administering the medication to the patients. Of course, the nurses are still required to record the detailed information regarding the types of medication, the amount of medication, the time of administering medication, and other information regarding the administration of the medicine.

Locked cabinets can provide efficient and accessible storage of medications using drawers with multiple bins for storing different medications. At the same time, locked cabinets prevent unauthorized access to the medications. Some medication cabinets incorporate a computer or microprocessor to selectively provide access to a particular drawer in response to an input requesting a specific medication.

Narcotics and other controlled substances require the greatest degree of access control. As indicated above, one approach to providing this control involves incorporating individually lockable bins in drawers containing narcotics or other controlled substances. This solution, however, presents a choice between storing a unit dose in each individual lockable bin, incurring considerable cost, or storing multiple doses in an individually-lockable bin, affording reduced security. Generally, drawbacks of previous systems were intensive labor and time requirements as well as the reduced security of the controlled substances while they are at the remote locations. The remote storage locations create a need for central control over a network for the storage depots. The control over remote locations is further complicated by a desire for constant or at least consistent, periodic communication through a network to a central processor.

System access and control are also critical to many users. As a result, many facilities use a clustered network configuration to guard against the system's network server failures. In some cases, wide area network links controlled by a third party are implemented and can have temporary or chronic network problems. It is rare to find a facility that never experiences any network problems. In prior practice, medication depots would either always operate offline, leaving the online data out of date until the time of synchronization or only operate online, in which case the procedures for offline use would provide only limited functionality and may not capture all of the information needed for the clinical profile of the patient and billing.

The present invention is provided to solve these and other problems.

### SUMMARY OF THE INVENTION

The present invention is generally directed to a device and method for controlling access to and tracking usage of medications in a locked storage cabinet or depot. An electronic accessory, such as a key, ring, card, or badge, is used to gain access to the cabinet or depot. The electronic identification key is fastened to an authorized individual, or key holder, or key holder's clothing, to assure access is terminated when the key holder leaves the cabinet or depot, by proximate removal of the electronic key.

According to one aspect of the invention, the electronic key comprises an electronic biometric identification. The electronic biometric identification can be a file containing identification information and stored in memory. The biometric identification can be a map of a biometric scan of the key holder for biometric confirmation of the identity of the key holder. The cabinet or depot is provided with a biometric scanner which performs a biometric scan. A processing unit in the depot or cabinet compares the biometric scan with the biometric identification for confirmation of the key holder's identity.

According to another aspect of the invention, the identity of the key holder is quickly verified because only one file is compared to the biometric scan instead of comparing a biometric scan to a library of files to identify an individual being scanned. The present invention provides one-to-one matching of biometric identification, requiring less time than a one-to-many identification process.

According to another aspect of the invention, the system provides enhanced security because it combines the protection of an encrypted electronic identification key with biometric matching of the key to the user. The encrypted identification code on the electronic key must match a code stored in a memory incorporated into the medical storage depot, and the encrypted identity confirmation file stored on the electronic key must match the biometric scan taken by a biometric scanner or sensor incorporated into the medical storage depot.

According to another aspect of the invention, the system can automatically terminate access to a medication storage depot when an authorized user possessing the electronic identification key moves away from the medication storage depot.

In still another aspect of the invention, the system is programmed to periodically synchronize the database of the local depot computer with the database of the central processor. The database information changes entered at either location are updated at the other database each time system synchronization is scheduled. The information changed, at either site, since the last system synchronization, is transferred to the other computer over the network communication link.

In still another aspect of the invention, the user has access to the most up-to-date information that is locally available. In order for this to happen, changes in user authentication and in the patient and inventory data for the particular depot are automatically downloaded to the depot periodically so the user has access to recent information. If the user needs to remove drugs for a patient who has arrived on the nursing unit after the most recent update before the network connection was lost, then the user has the capability to enter the encounter locator and patient name for temporary storage.

In still another aspect of the invention, the system is designed to automatically reconnect if a network connection goes down or there is some other interruption in service. Also, even with the network down, the user can use a database local to the depot to continue to operate the system. The depot captures the information locally and when the network connection is restored, sends the data to the server so it can be stored just as if the network connection was never dropped.

In still another aspect of the invention, when a database modification causes an error that is discovered upon synchronization, the user is notified to correct the information before the upload is allowed. The user can correct the data in error so that it can upload correctly or clear it if the correct information has been entered by another means.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front view of a medical cabinet, in accord with the present invention;

FIG. 2 is a perspective view of the medical cabinet of FIG. 1, with access by a user having an electronic identification key, and including a biometric fingerprint scanner;

FIG. 3 is the simplified block diagram of the information collection, processing, and controlling equipment within a computer associated with the medical cabinet computer of FIG. 1; and

FIG. 4 is a simplified block diagram of a local area network connected to the medical cabinet of FIG. 1.

### DETAILED DESCRIPTION

While the present invention is susceptible to embodiments in many different forms, there are shown in the drawings and will herein be described in detail, preferred embodiments of the invention with the understanding that the present disclosures are to be considered as exemplifications of the principles of the invention and is not intended to limit the broad aspect of the invention to the embodiments illustrated.

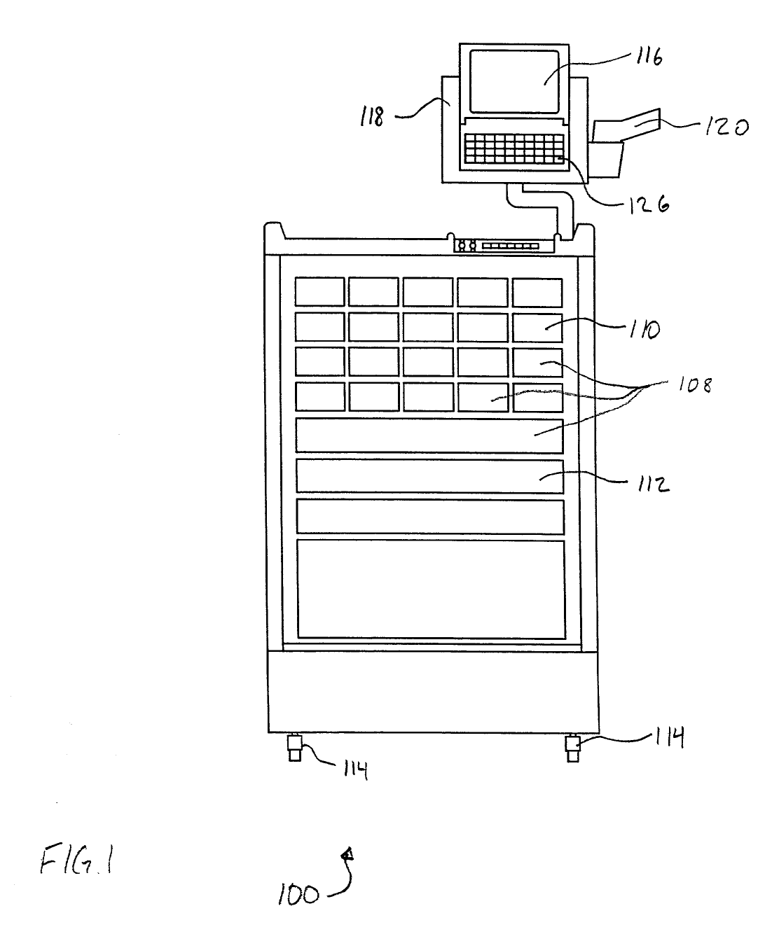

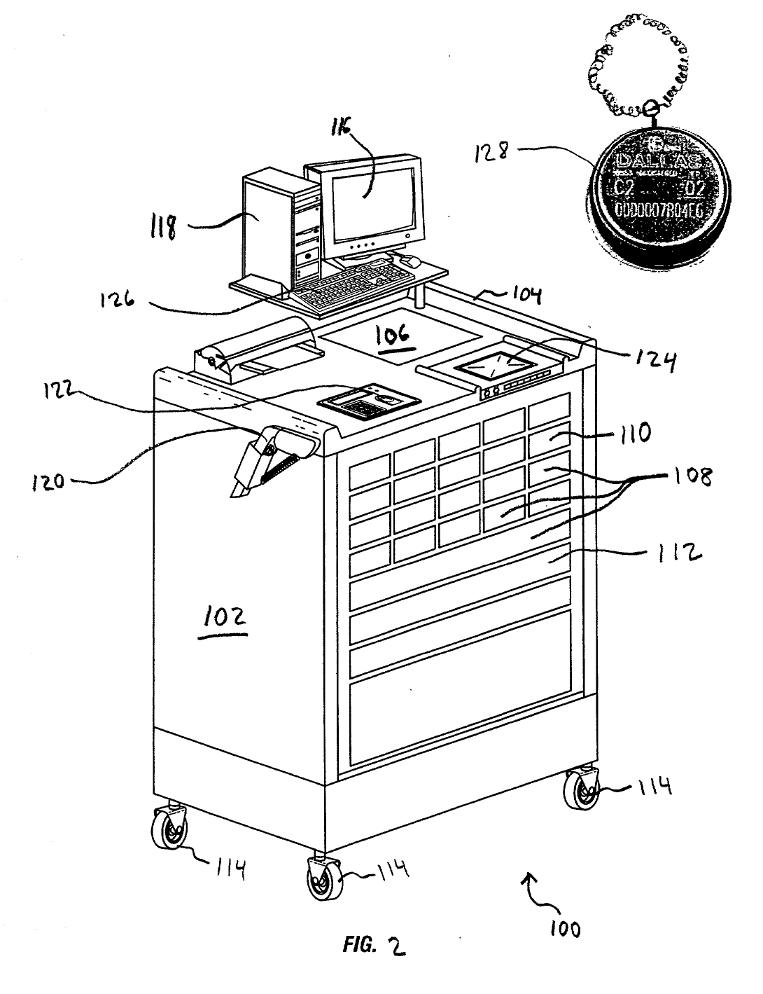

Referring to FIGS. 1 and 2, therein is shown an embodiment of a medical storage cabinet or depot generally referred to by the reference numeral 100. Reference numbers for the common elements represented in FIGS. 1 and 2 will be denoted similarly. The medical storage depot 100 has a front panel 102, a handle 104 at the back, a top work surface 106, and a plurality of drawers 108. In one embodiment, the drawers are available in multiple sizes, small individual patient drawers 110 and large drawers 112, to carry on-demand drugs and supplies. Preferably, all of the medical storage depot drawers 108, 110, 112 are normally locked as explained in detail further herein. The medical cabinet chassis or housing is carried on casters 114 sized for ease of use and mobility.

Mounted to the medical storage depot 100 is a touch display screen 116 and a computer 118 operably connected together. The screen 116 allows for a user to visually read information provided by the computer 118, and enter data into the computer memory. The computer 118 provides control of the electrical systems within the medical storage depot. Besides the touch display screen 116, data may be entered into the computer 118 from a keyboard 126, bar code reader 120, or other means.

Attached to the medical storage depot 100, and connected to the processor 118, is a biometric fingerprint scanner 122 and an electronic identification key port 124. The scanner 122 allows for biometric images, such as fingerprints, to be read. The scanned biometric images are typically digitized by the scanner 122 and stored in a memory. Scanned images are used by the processor 118 to determine medical storage depot 100 access. The new scanned image is compared to another image previously stored in the memory of the processor 118. When a comparison of the two images indicates an equivalence level adequate to deem the biometric images as stemming from the same source, a biometric match is registered and access to the medical storage depot 100 is granted. When a biometric match is determined by the computer 118, the appropriate drawers 108, 110, 112 of the medical storage depot are unlocked and the user may open the drawers 108, 110, 112 and remove any necessary items.

Fingerprints are a preferred method of biometric identification. The skin on the inside surfaces of hands, fingers, feet, and toes are “ridged” or covered with concentric raised patterns. These ridges are called friction ridges and they serve the useful function of making it easier to grasp and hold onto objects and surfaces without slippage. It is the many differences in the way friction ridges are patterned, broken, and forked which make ridged skin areas, including fingerprints, unique.

Attached to or carried by the user is an electronic identification key 128. The electronic identification key 128 is adapted for use with an electronic key identification port 124, the port 124 connected to the processor 118. When the key 128 is close enough to the port 124 to be read, the port 124 is capable of receiving information stored in the key 128. The information received relates to the identification of the key holder/user. The processor 118 receives the identification information through the electronic key identification port 124 and uses the information to select the particular biometric image stored in the memory of the processor 118 that is associated with the user of the key 128. The processor 118 compares this image with an image stored in memory. Cabinet 100 access is restricted when the two images are not substantially similar and access is allowed when the images are determined to be the same. Alternatively, the information stored in and received from the electronic key 128 by the port 124 is a biometric image of the key user to be used in the above mentioned comparison.

The present medical storage depot 100 is quite durable and easy to use. First, the drawers 108, 110, 112 are stocked. Normally this will be done on a daily basis in accordance with the schedule established by the pharmacy. An official list of health care personnel who can open the medical storage depot is stored in a database of its computer 118. The local computer 118 also retains the inventory of the cart 100 in memory. A complete and accurate list of medical storage depot 100 contents is to be updated with every change in inventory.

Once stocked, the health care provider pushes the medical storage depot 100 to a patient's room near a patient's bedside. She then places an electronic identification key 128 into the electronic key identification port 124. The identification information from the key 128 is loaded into the computer 118 through the key identification port 124. The computer 118 uses the loaded information to determine the identity of the authorized key holder. The display 116 now prompts the user to input her biometric data so as to verify the authorized key holder's identity. In response, the health care provider places her hand on the fingerprint scanner 122 to read her biometric information. The medical storage depot computer 118 records the electronic identification key's 128 information and recalls the corresponding biometric information associated with the specific user. The purpose of this file is to verify recognition of this particular user. The medical storage depot computer 118 also loads the fingerprint image scanned at the biometric reader 122 into its memory. The computer 118 then compares the stored biometric image associated with electronic identification key 128 with the biometric information read at the fingerprint scanner 122. If the scanned and stored images match, then the health care provider is allowed limited access to selected drawers 108, 110, 112 of the medical storage depot 100. The combination of an electronic identification key 128 in operational proximity of the medical storage depot 100 and a verified biometric match grants the user access.

The health care provider then identifies the patient to be treated and the medication which is required. A medical history file for each patient is retained by the computer 118. The medical storage depot computer 118 has been programmed so that in memory there will be an identification of the patients to which each patient drawer 110 corresponds. There will also be information as to what is contained in the larger on-demand drawers 112 and the small individual patient drawers 110. Thus, when the computer 118 or processing unit sees the patient identification and medication being requested it will cause a drawer lock to unlock the appropriate patient drawer 110 or on demand drawer 112.

Once the authorized user has provided the necessary identification, the processor 118 operates to cause the desired substance to be dispensed or made accessible to the user. The user is also required to input the corresponding patient data so that the patient's chart and billing may be updated. The health care provider removes the patient medication from the drawer 110, administers it to the patient and closes the drawer 110. At that point, the display 116 will request the health care provider to confirm that the medication has been dispensed to the proper patient. Upon receiving that information the medical storage depot 100 may either store the information in memory 118 or transmit it to an external computer through a transmitter/receiver, preferably over a local area network.

The medical storage depot 100 can also be used to receive information about the patient. Patient information is contained in the local computer 118 memory or received from the master computer over a local area network. Thus, after entering an access code and patient information, the health care provider could enter diagnostic information, view the medical history or receive other information which is not required for dispensing medicine. Hence, the medical storage depot 100 becomes a focal point for patient treatment.

It should be noted that no special wiring is required to be installed for a hospital to use this portable medical storage depot 100. The medical storage depot 100 is sufficiently large to accommodate drawers 108, 110, 112 for a maximum number of patients normally assigned to one health care provider. Hence, our portable medical storage depot 100 could be assigned to an individual health care provider on each shift. The health care provider could store her stethoscope, thermometer or other equipment in any of the larger drawers 112.

Further, removing the electronic identification key 128 from the specified proximity of the key identification port 124 of the medical storage depot 100 terminates access to the medical storage depot drawers 108, 110, 112. Once the electronic identification key 128 is moved a predetermined distance away from the key identification port 124, the drawers 108, 110, 112 of the medical storage depot 100 are automatically locked. Access is restricted until the combination of an electronic key 128 in operational proximity of the medical storage depot 100 and a verified biometric match reoccurs.

The medical storage depot 100 includes a computer 118 which includes a user interface 116 and is connected to the processing system and the counters. The data stored in the computer 118 includes records concerning patients, procedures, authorized users of the system and each of the products stored in each of the locations within the medical storage depot 100, even including pricing information. The user, such as a technician or nurse, uses the interface of the data display 116 to identify the particular patient who is to receive the medical items removed by the user. Upon removal of the items from the drawers 108, 110, 112 or storage locations, the use of such items is recorded in the patient record in the data stored on the computer 118 so that the patient's chart may be automatically updated and the item charged. In addition, a user using the display may review a wealth of information in the data store concerning health care personnel and medical procedures to determine what medical items are required by a physician to conduct a procedure. Necessary items can be electronically allocated and removed from the medical storage depot for delivery to an operating room or patient.

The invention provides for controlled access to the articles within the drawers by requiring certain information, e.g., user identification, patient identification, and/or article identification information, to be entered into the controller before access to the supplies will be afforded. In particular, access to specific compartments within each drawer is controlled so that only certain articles which have been preselected are made available for removal. Although useful in storing most medical supplies and pharmaceuticals, dispensing systems of the present invention will find their greatest use in storing pharmaceuticals that require high levels of security and whose availability in single dose quantities is desired.

In a preferred embodiment, an identity verification system for a healthcare facility includes a lockable medical storage depot 100, an electronic key 128, a memory with an electronic biometric identification associated with the electronic key 128, a biometric scanner 122 that communicates with the depot 100 and scans biological characteristics to generate another electronic biometric identification. A processor 118 compares the electronic biometric identifications and generates a medical storage depot access signal.

The proper electronic identification can be indicated in several ways. The electronic key 128 can download identification location information for locating the electronic biometric identification in the memory of the system 100. The electronic key 128 can also store electronic biometric identification in its resident memory for use in the biometric comparison for access to the lockable medical storage depot 100.

The memory containing the electronic biometric identification associated with the electronic key 128 can be located at the lockable medical storage depot 100. Alternatively, the memory containing the electronic biometric identification associated with the electronic key 128 can be centrally located, apart from the lockable medical storage depot 100.

The system tracks attempts to access the contents of the medical storage depot 100. When the electronic biometric identifications match, the processor 118 generates the medical storage depot access signal as an unlock signal. When the scanned and stored electronic biometric identifications do not match, the processor 118 generates a message indicating that access has been denied and sends the message to a display screen or other user interface 116. The user interface 116 can be, but is not limited to, a computer display 116 with a keyboard 126 or a handheld personal digital assistant and the message indicating that access has been denied can be sent to the personal digital assistant.

In one embodiment, a depot memory containing a copy of the electronic biometric identification is located at the lockable medical storage depot 100. A central memory containing another copy of the electronic biometric identification is located apart from the lockable medical storage depot 100. The lockable medical storage depot 100 can communicate with the central memory and the depot memory can track the central memory. When communication between the lockable medical storage depot 100 and the central memory is lost, the processor 118 can compare the copy of the electronic biometric identification and the other electronic biometric identification to generate the medical storage depot access signal.

In another embodiment, the depot memory contains a copy of the electronic biometric identification and is located at the lockable medical storage depot 100. A central memory containing another copy of the electronic biometric identification is located in a area remote from the lockable medical storage depot 100. The lockable medical storage depot 100 can communicate with the central memory and the depot memory tracks the central memory. The processor 118 compares the copy of the electronic biometric identification and the other electronic biometric identification to generate the medical storage depot access signal.

The system preferably includes a key sensor 124 for determining the location of the electronic key 128. When the electronic key 128 is within a specific proximate distance from the key sensor 124, the medical storage security process begins to determines access credentials. The key sensor 124 can determine whether the electronic key 128 is within a predetermined distance from the key sensor 124. The predetermined operable distance between the electronic key 128 and the key sensor 124 is user definable.

A medical storage depot access termination signal can be sent when the electronic key 128 is positioned at a predetermined distance from a key sensor 124. Preferably, the key sensor 124 is attached to the lockable medical storage depot 100. In another embodiment, the key sensor 124 is a port for receiving the electronic key 128.

The key sensor 124 can receive identification location information for locating the electronic biometric identification in the memory. The lockable medical storage depot 100 can include multiple lockable drawers 108, 110 and non-locking drawers 112.

The memory preferably has a patient order associated with a patient record, the patient order having an item identified. The processor 118 generates the medical storage depot access signal for unlocking only the portion of the lockable medical storage depot that contains the item necessary to fulfill the patient order.

The lockable medical storage depot 100 can be mobile and portable. The wheels 114 allow the depot 100 to be rolled to a location to provide efficient and convenient access. A preferred location for the lockable medical storage depot 100 is in near proximity to the patient and readily available for patient assistance.

In a preferred embodiment, the biometric scanner 122 can scan fingerprints, eyes, a voice and handwriting. The biometric scanner 122 can be adapted to scan a plurality of biological characteristics. The biometric identification location information of the electronic key 128 is preferably encrypted. Preferably, the electronic key 128 in use with the system is an IBUTTON 128.

The memory of the lockable medical storage depot 100 can be representative of a medical item inventory of the lockable medical storage depot 100. The memory may also be representative of authorized users of the lockable medical storage depot 100. Also, the memory can be data representative of a list of access attempts to the lockable medical storage depot 100. The medical storage depot access signal unlocks the appropriate lockable medical storage depot drawers 108, 110, 112 when a proper identification match occurs.

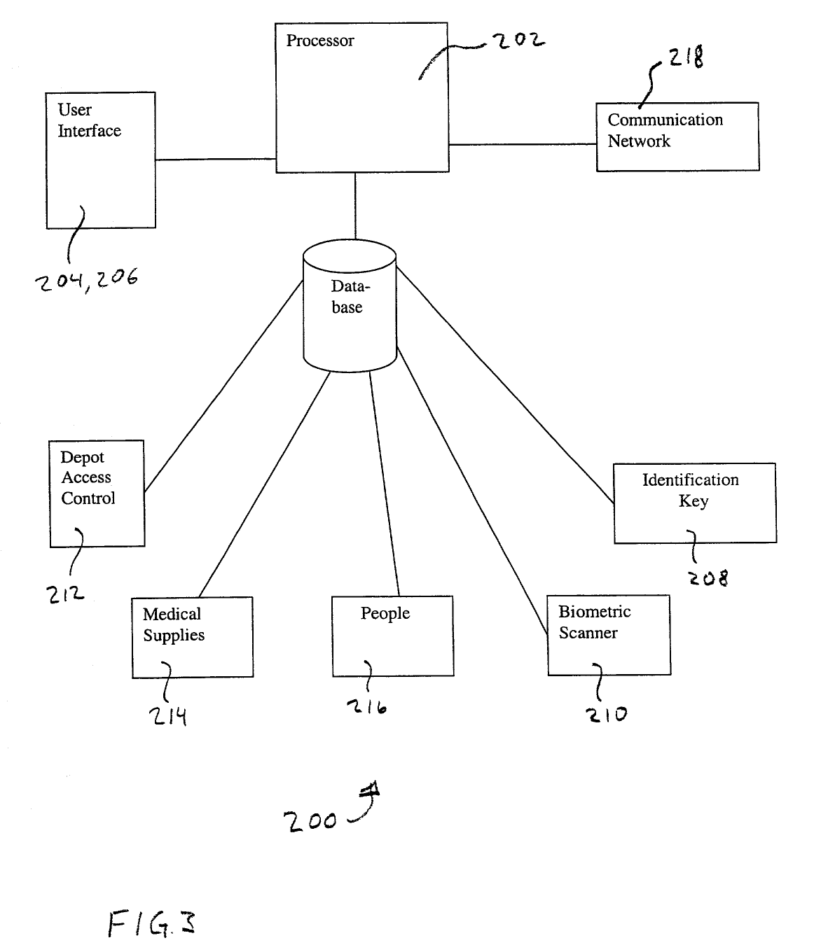

Referring to FIG. 3, therein is shown a block diagram of one embodiment of the information collection, processing, and controlling equipment in the medical storage depot computer with the reference number 200. The computer 200 has a processor and memory 202 and several forms of user interface. The user interface can be a display screen 206 and a keyboard 204, but the computer 200 is not limited to these forms of input and output. Examples of other user interface devices include bar code scanners, personal digital assistants, touch screens, printers and many others.

The computer 200 can optionally operate as a node on a communication network 218. Network communication with a remote controlling processor can provide reliability through a redundancy of the data stored in the respective memories.

The computer 200 stores and processes a variety of data. One category of information is a database of medical supplies 214. Medical supply information 214 regarding the contents of each drawer may be scanned with a hand-held scanner reading a bar code label that was placed on each receptacle at the batch facility. Data obtained from the information storage device and/or from scanning the bar code labels may be stored in the computer 202 for inventory control purposes. As users and operators of the medical storage depot enter information to gain access to the contents of the receptacles, the operator-entered information can be delivered to the computer to maintain a real-time inventory of each receptacle in each storage depot. The information storage may also maintain real-time inventory of the receptacle's contents as users/operators gain access to the contents of the medical storage depot drawers.

Another category of computer data may be generally referred to as people 216. The computer retains and processes information relating to patients and health care personnel. This data class can encompass a patient's entire health history and future medical needs. The computer stores the identity of health care providers who are allowed access to the medical storage depot. Some of the health care providers can be physicians, nurses, pharmacists and even the engineers who maintain the storage depot electronics.

The information relating to people 216 is affiliated to the data stored for the electronic identification key 208. This category of information correlates the identification of the individual assigned to the key with his or her biometric data. When using an electronic identification key, the user enlists the computer to recall a specific biometric identification from its memory. The biometric identification is directly and uniquely associated to the assignee of the electronic identification key. The recalled file will be compared to biometric information read by a scanner 210. Algorithms governing the biometric scanner 210 and identification comparison reside in the medical storage depot computer. Once an authorized identity is established, the computer also controls depot access 212. User access to the medical storage depot can be limited to certain compartments or specific drawers.

Referring again to FIGS. 1 and 2, biometrics are the technology and science of statistically analyzing measured biological data. Biometrics, the measurement of a unique physical characteristic, are an ideal solution to the problem of digital identification. Biometrics make it possible to identify individuals to digital systems, and through these systems identify individuals to medical devices and applications. With a biometric profile, a digital persona is created that makes transactions and interactions more convenient and secure. Biometric features for identification include fingerprint, face, iris and retina scanning, voice identification, and others. Biometric devices consist of a scanning or reading device, software to convert the scanned information into a digital format, and a memory to store the biometric information for comparison with a stored record. Software identifies specific matched points of data that have been processed with an algorithm and compares the data. Unlike passwords, PIN codes, and smartcards that we depend upon today for identification, our biometric profiles are impossible to lose or forget, and they can never be stolen.

The performance of biometric algorithms is measured as a tradeoff between two attributes, False Acceptance Rate (FAR) which is the probability that an intruder will be accepted by the system, and False Rejection Rate (FRR) which is the probability that a legitimate person will be rejected by the system. FAR and FRR offset each other and can be stated only in terms that are relative to one another.

An embodiment of the invention combines the use of an electronic identification key 128, having electronic biometric identification, with a biometric scanner 122. When a user places the electronic key 128 within a specified distance of the medical device, a processor knows the specific individual electronic biometric identification it should expect. The system preferably prompts the user to scan their biometric information. The biometric information is entered into the system with some type of biometric reading or scanning device 122. A one-to-one comparison is made between the scanned biometric information and the previously-stored specific individual electronic biometric identification. This one-to-one identity comparison is more efficient than comparing one-to-many identity files because it does not require searching an entire user database for a match. Instead, only one specific comparison is made. If there is a match, then the user is granted access to the medical device 100; otherwise, user access is denied.

In another embodiment, after user access to the system has been granted through the verification process, system access can be terminated when the electronic key 128 is removed from the system. The proximate distance of the electronic identification deice or key 128 from the system where access terminates is predetermined by the system parameters. In yet another embodiment, the operative distance is a variable and programmable system parameter.

The preferred digital identification technique includes recording an encrypted digital fingerprint template along with users' name, login name and passwords on an electronic identification device such as an IBUTTON 128 sold by Dallas Semiconductor. The IBUTTON 128 is a token-shaped module for housing an electronic circuit. A module houses electronic circuitry that comprises a first electrically conductive surface area and a second electrically conductive surface. The first and second electrically conductive surfaces combine to form a substantially token-shaped body. The body has a groove positioned around its perimeter. A probe has a first end and a second end. A conductive, approximately pointed tip extends from the first end of the probe and a conductive sleeve extends outward from the pointed tip from a location proximate to said first end to a second distance. A first electrical connection contacts the tip and extends from the first end through the probe out the second end. A second electrical connection contacts the sleeve and extends from the first end through the probe out from the second end. A housing holds an electronic module. The electronic module has a first surface and a second surface. The housing comprises a first end and a second end; and a hole positioned in the first end allows an electronic module to be inserted therethrough. An electronic module connector is shaped to receive an electronic module comprising a first conductive surface positioned on the perimeter of the electronic module connector, the first surface being raised. A second conductive surface extends horizontally at an angle to the first surface. A bracelet is provided for housing an electronic module that has a first conductive surface and a second conductive surface. The bracelet comprises a housing to hold the electronic module so that the first and second conductive surfaces can be contacted from outside, and a band is mechanically coupled to the housing.

When the user attaches the IBUTTON 128 with its recorded information, the system reads the information and invites the user to put his or her finger on the fingerprint scanner 122. The system then provides comparison of a digital fingerprint template recorded on the IBUTTON 128 with the real fingerprint image obtained from the user. According to the comparison result, the system either provides a login for this user, to different applications using login names and passwords read from IBUTTON 128, or rejects the user if the digital fingerprint template doesn't match the obtained finger's image. Additional personal information or images can be recorded on the IBUTTON 128 to provide higher level of security.

To use the IBUTTON 128 for identification you need to have preprogrammed IBUTTON 128 that contains digital fingerprint template, names and passwords. IBUTTON 128 information might be changed only by authorized person using special IBUTTON 128 with administrative rights.

User should attach IBUTTON 128 to the IBUTTON 128 receptor or key sensor 124 properly to provide reliable contacts for IBUTTON 128 and key sensor 124. Then when message “Put your finger on the sensor” appears on the display screen 116, the user can place her finger on the fingerprint scanner 122. The finger to be scanned should not be too dry. To provide the perfect fingerprint, the user should touch her forehead before placing her finger on the biometric scanner 122. It's also important that central area of the finger was properly placed on the biometric scanner 122. If the system 100 doesn't recognize the fingerprint, the user is informed by an error message about an improper identification and directed to attach her finger to the biometric scanner 122 to attempt access again. In case of successful identification, the system 100 provides a login process for users to access other system features.

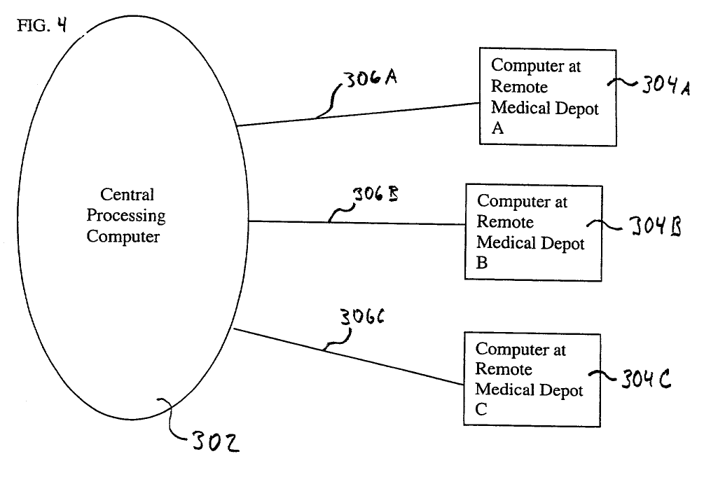

Referring now to FIG. 4, in yet another embodiment, a cart or depot containing secured medical supplies is stationed in a location remote from a system central processing computer 302. The cart has a local computer 304 with a network communication connection 306 to the system's central processor 302. Both the local computer 304 and the central processor 302 have a database used for access, monitor and control of the medical supply cart. Database updates can be entered at the remote 304 or central 302 location. The updates are then synchronized with the other database over the network 306. Network database synchronization updates are programmed to occur at predefined specific times so long as the network communication link 306 is working.

In yet another embodiment, the remote depot allows user access to the information stored in the computer 304 and the supplies in the medical depot drawers even when the network communication link 306 is broken. The local computer 304 uses the most recent version of its locally stored database information for accessing, monitoring and controlling the medical supply cart. Both the local computer 304 and central processor 302 operate as though the network communication 306 were active. When network connection 306 is reestablished, the local and central databases are synchronized with any information modified at the other location so that both system databases are properly updated.

In yet another embodiment, the database synchronization cycle, prompted by a newly reestablished network communication 306 connection or a regularly scheduled update, can have an entry error. When these entry errors are discovered by the system, the user is prompted to correct the information in the pending upload so that it can be properly uploaded, or clear the error to allow the correct information to be entered by other means.

While the specific embodiments have been illustrated and described, numerous modifications can be made to the present invention, as described, by those of ordinary skill in the art without significantly departing from the spirit of the invention. The breadth of protection afforded this invention should be considered to be limited by the scope of the accompanying claims.

What is claimed is:

1. An identity verification system for a healthcare facility, comprising:
a lockable medical storage depot;
an electronic key;
a memory having a first electronic biometric identification associated with the electronic key;
a biometric scanner communicating with the lockable medical storage depot for scanning at least one biological characteristic and for generating a second electronic biometric identification; and,
a processor for comparing the first and second electronic biometric identifications and for generating a medical storage depot access signal.

2. The system of claim 1 wherein the electronic key comprises identification location information for locating the first electronic biometric identification in the memory.

3. The system of claim 1 wherein the electronic key comprises the memory having the first electronic biometric identification.

4. The system of claim 1 wherein when the first and second electronic biometric identifications do not match, the processor generates a message indicating that access has been denied for sending to a user interface.

5. The system of claim 4 wherein the user interface is a handheld personal digital assistant, and wherein the message indicating that access has been denied is sent to the personal digital assistant.

6. The system of claim 1 wherein when the first and second electronic biometric identifications match, the processor generates the medical storage depot access signal as an unlock signal.

7. The system of claim 1 wherein the memory containing the first electronic biometric identification associated with the electronic key is located at the lockable medical storage depot.

8. The system of claim 1 wherein the memory containing the first electronic biometric identification associated with the electronic key is centrally located apart from the lockable medical storage depot.

9. The system of claim 1 wherein the memory comprises:
a depot memory containing a first copy of the first electronic biometric identification, located at the lockable medical storage depot; and,
a central memory containing a second copy of the first electronic biometric identification, located apart from the lockable medical storage depot, wherein the lockable medical storage depot can communicate with the central memory, wherein the depot memory tracks the central memory, and wherein when communication between the lockable medical storage depot and the central memory is lost, the processor compares the first copy of the first electronic biometric identification and second electronic biometric identification, for generating the medical storage depot access signal.

10. The system of claim 1 wherein the memory comprises:
a depot memory containing a first copy of the first electronic biometric identification, located at the lockable medical storage depot; and,
a central memory containing a second copy of the first electronic biometric identification, located apart from the lockable medical storage depot, wherein the lockable medical storage depot can communicate with the central memory, wherein the depot memory tracks the central memory, and wherein the processor compares the second copy of the first electronic biometric identification and second electronic biometric identification, for generating the medical storage depot access signal.

11. The system of claim 1 further comprising:
a key sensor for determining the location of the electronic key in relation to the key sensor, including whether the electronic key is within a predetermined distance from the key sensor.

12. The system of claim 11 wherein the predetermined distance is user definable.

13. The system of claim 1 further comprising:
a medical storage depot access termination signal adapted to be activated when the electronic key is positioned at a predetermined distance from a key sensor.

14. The system of claim 13 wherein the key sensor is attached to the lockable medical storage depot.

15. The system of claim 13 wherein the key sensor is a port for receiving the electronic key.

16. The system of claim 13 wherein the key sensor receives identification location information for locating the first electronic biometric identification in the memory.

17. The system of claim 13 wherein the key sensor receives the first electronic biometric identification.

18. The system of claim 1 wherein the lockable medical storage depot comprises a plurality of lockable drawers and a plurality of non-locking drawers.

19. The system of claim 1 wherein the memory further comprises a patient order associated with a patient record, the patient order having an item identified therein, and wherein the processor generates the medical storage depot access signal for unlocking only a portion of the lockable medical storage depot containing the item for fulfilling the patient order.

20. The system of claim 1 wherein the lockable medical storage depot is mobile.

21. The system of claim 1 wherein the biometric scanner is adapted to scan at least one of a fingerprint, an eye, a voice and a handwriting sample.

22. The system of claim 2 wherein the identification location information in the electronic key is encrypted.

23. The system of claim 1 wherein the biometric scanner is adapted to scan a plurality of biological characteristics.

24. The system of claim 1 wherein the electronic key is an IBUTTON.

25. The system of claim 1 wherein the memory further comprises data representative of a medical item inventory of the lockable medical storage depot.

26. The system of claim 1 wherein the memory further comprises data representative of authorized users of the lockable medical storage depot.

27. The system of claim 1 wherein the memory further comprises data representative of a list of access attempts to the lockable medical storage depot.

28. The system of claim 1 wherein the medical storage depot access signal unlocks the lockable medical storage depot.

29. A method of verifying a user identity for accessing a lockable medical storage depot with the use of an electronic key, the method comprising the steps of:
storing a first electronic biometric identification associated with the electronic key;
scanning at least one biological characteristic representative of the user identity;
generating a second electronic biometric identification;
comparing the first and second electronic biometric identifications; and,
generating a medical storage depot access signal in response to the step of comparing the first and second electronic biometric identifications.

30. The method of claim 29 further comprising the step of:
unlocking the lockable medical storage depot for user access when the electronic biometric identifications match.

31. The method of claim 29 further comprising the step of:
locating the first electronic biometric identification with identification location information of the electronic key.

32. The method of claim 29 further comprising the step of:
storing the first electronic biometric identification in the electronic key.

33. The method of claim 29 further comprising the steps of:
generating a message indicating that access has been denied when the first and second electronic biometric identifications do not match; and
sending the message to a user interface.

34. The method of claim 33 wherein the user interface is a handheld personal digital assistant, and wherein the message indicating that access has been denied is sent to the handheld personal digital assistant.

35. The method of claim 29 further comprising the step of:
generating the medical storage depot access signal as an unlock signal when the first and second electronic biometric identifications match.

36. The method of claim 29 further comprising the step of:
storing the first electronic biometric identification associated with the electronic key at the lockable medical storage depot.

37. The method of claim 29 further comprising the step of:
storing the first electronic biometric identification associated with the electronic key at a location apart from the lockable medical storage depot.

38. The method of claim 29 further comprising the steps of:
storing a first copy of the first electronic biometric identification in a depot memory located at the lockable medical storage depot; and,
storing a second copy of the first electronic biometric identification in a central memory located apart from the lockable medical storage depot, wherein the lockable medical storage depot can communicate with the central memory, wherein the depot memory tracks the central memory, and wherein when communication between the lockable medical storage depot and the central memory is lost, a processor compares the first copy of the first electronic biometric identification and second electronic biometric identification, for generating the medical storage depot access signal.

39. The method of claim 29 further comprising the steps of:
storing a first copy of the first electronic biometric identification in a depot memory located at the lockable medical storage depot; and,
storing a second copy of the first electronic biometric identification at a central memory located apart from the lockable medical storage depot, wherein the lockable medical storage depot can communicate with the central memory, wherein the depot memory tracks the central memory, and wherein a processor compares the second copy of the first electronic biometric identification and second electronic biometric identification, for generating the medical storage depot access signal.

40. The method of claim 29 further comprising the step of:
determining the location of the electronic key in relation to a key sensor, including whether the electronic key is within a predetermined distance from the key sensor.

41. The method of claim 40 wherein the predetermined distance is user definable.

42. The method of claim 29 further comprising the step of:
activating a medical storage depot access termination signal when the electronic key is positioned at a predetermined distance from a key sensor.

43. The method of claim 40 further comprising the step of:
attaching the key sensor to the lockable medical storage depot.

44. The method of claim 40 wherein the key sensor is a port for receiving the electronic key.

45. The method of claim 40 further comprising the step of:
receiving identification location information at the key sensor for locating the first electronic biometric identification.

46. The method of claim 40 further comprising the step of:
receiving the first electronic biometric identification at the key sensor.

47. The method of claim 29 wherein the lockable medical storage depot comprises a plurality of lockable drawers and a plurality of non-locking drawers.

48. The method of claim 29 further comprising the steps of:
associating a patient order with a patient record, the patient order having an item identified therein; and,
generating the medical storage depot access signal for unlocking only a portion of the lockable medical storage depot containing the item for fulfilling the patient order.

49. The method of claim 29 wherein the lockable medical storage depot is mobile.

50. The method of claim 29 wherein the biological characteristic representative of the user identification is at least one of a fingerprint, an eye, a voice and a handwriting sample.

51. The method of claim 29 further comprising the step of:
encrypting information stored in the electronic key.

52. The method of claim 29 further comprising the step of:
scanning a plurality of the biological characteristic representative of the user identification.

53. The method of claim 29 wherein the electronic key is an IBUTTON.

54. The method of claim 29 further comprising the step of:
storing data representative of a medical item inventory of the lockable medical storage depot.

55. The method of claim 29 further comprising the step of:
storing data representative of authorized users of the lockable medical storage depot.

56. The method of claim 29 further comprising the step of:
storing data representative of a list of access attempts to the lockable medical storage depot.

57. The method of claim 29 further comprising the step of:
denying access to the lockable medical storage depot when the electronic biometric identifications do not match.

58. A computer readable medium for verifying a user identity for accessing a lockable medical storage depot with the use of an electronic key, the medium comprising:
a first code segment for storing a first electronic biometric identification associated with the electronic key;
a second code segment for scanning at least one biological characteristic representative of the user identity;
a third code segment for generating a second electronic biometric identification;
a fourth code segment for comparing the first and second electronic biometric identifications; and,
a fifth code segment for generating a medical storage depot access signal in response to the step of comparing the first and second electronic biometric identifications.

59. The computer readable medium of claim 58 further comprising:
a sixth code segment for unlocking the lockable medical storage depot for user access when the electronic biometric identifications match.

60. The computer readable medium of claim 58 further comprising:
a sixth code segment for locating the first electronic biometric identification with identification location information of the electronic key.

61. The computer readable medium of claim 58 further comprising:
a sixth code segment for storing the first electronic biometric identification in the electronic key.

62. The computer readable medium of claim 58 further comprising:
a sixth code segment for generating a message indicating that access has been denied when the first and second electronic biometric identifications do not match; and
a seventh code segment for sending the message to a user interface.

63. The computer readable medium of claim 62 wherein the user interface is a handheld personal digital assistant, and wherein the message indicating that access has been denied is sent to the handheld personal digital assistant.

64. The computer readable medium of claim 58 further comprising:
a sixth code segment for generating the medical storage depot access signal as an unlock signal when the first and second electronic biometric identifications match.

65. The computer readable medium of claim 58 further comprising:
a sixth code segment for storing the first electronic biometric identification associated with the electronic key at the lockable medical storage depot.

66. The computer readable medium of claim 58 further comprising:
a sixth code segment for storing the first electronic biometric identification associated with the electronic key at a location apart from the lockable medical storage depot.

67. The computer readable medium of claim 58 further comprising:
a sixth code segment for storing a first copy of the first electronic biometric identification in a depot memory located at the lockable medical storage depot; and,
a seventh code segment for storing a second copy of the first electronic biometric identification in a central memory located apart from the lockable medical storage depot, wherein the lockable medical storage depot can communicate with the central memory, wherein the depot memory tracks the central memory, and wherein when communication between the lockable medical storage depot and the central memory is lost, a processor compares the first copy of the first electronic biometric identification and second electronic biometric identification, for generating the medical storage depot access signal.

68. The computer readable medium of claim 58 further comprising:
a sixth code segment for storing a first copy of the first electronic biometric identification in a depot memory located at the lockable medical storage depot; and,
a seventh code segment for storing a second copy of the first electronic biometric identification at a central memory located apart from the lockable medical storage depot, wherein the lockable medical storage depot can communicate with the central memory, wherein the depot memory tracks the central memory, and wherein a processor compares the second copy of the first electronic biometric identification and second electronic biometric identification, for generating the medical storage depot access signal.

69. The computer readable medium of claim 58 further comprising:
a sixth code segment for determining the location of the electronic key in relation to a key sensor, including whether the electronic key is within a predetermined distance from the key sensor.

70. The computer readable medium of claim 69 wherein the predetermined distance is user definable.

71. The computer readable medium of claim 58 further comprising:
a sixth code segment for activating a medical storage depot access termination signal when the electronic key is positioned at a predetermined distance from a key sensor.

72. The computer readable medium of claim 69 further comprising:
a seventh code segment for attaching the key sensor to the lockable medical storage depot.

73. The computer readable medium of claim 69 wherein the key sensor is a port for receiving the electronic key.

74. The computer readable medium of claim 69 further comprising:
a seventh code segment for receiving identification location information at the key sensor for locating the first electronic biometric identification.

75. The computer readable medium of claim 69 further comprising:
a seventh code segment for receiving the first electronic biometric identification at the key sensor.

76. The computer readable medium of claim 58 wherein the lockable medical storage depot comprises a plurality of lockable drawers and a plurality of non-locking drawers.

77. The computer readable medium of claim 58 further comprising:
a sixth code segment for associating a patient order with a patient record, the patient order having an item identified therein; and,
a seventh code segment for generating the medical storage depot access signal for unlocking only a portion of the lockable medical storage depot containing the item for fulfilling the patient order.

78. The computer readable medium of claim 58 wherein the lockable medical storage depot is mobile.

79. The computer readable medium of claim 58 wherein the biological characteristic representative of the user identification is at least one of a fingerprint, an eye, a voice and a handwriting sample.

80. The computer readable medium of claim 58 further comprising:
a sixth code segment for encrypting information stored in the electronic key.

81. The computer readable medium of claim 58 further comprising:
a sixth code segment for scanning a plurality of the biological characteristic representative of the user identification.

82. The computer readable medium of claim 58 wherein the electronic key is an IBUTTON.

83. The computer readable medium of claim 58 further comprising:
a sixth code segment for storing data representative of a medical item inventory of the lockable medical storage depot.

84. The computer readable medium of claim 58 further comprising:
a sixth code segment for storing data representative of authorized users of the lockable medical storage depot.

85. The computer readable medium of claim 58 further comprising:
a sixth code segment for storing data representative of a list of access attempts to the lockable medical storage depot.

86. The computer readable medium of claim 58 further comprising:
a sixth code segment for denying access to the lockable medical storage depot when the electronic biometric identifications do not match.
